(19) United States
(12) Patent Application Publication
(10) Pub. No.: US 2007/0028599 A1
(43) Pub. Date: Feb. 8, 2007

(54) Method and device for operating an internal combustion engine

(76) Inventors: Dirk Hartmann, Stuttgart (DE); Werner Mezger, Eberstadt (DE); Andreas Roth, Muehlacker-Lomersheim (DE); Juergen Rappold, Ilsfeld-Auenstein (DE); Georg Mallebrein, Korntal-Muenchingen (DE); Nikolas Poertner, Stuttgart (DE); Henri Barbier, Schwieberdingen (DE); Ingo Fecht, Ludwigsburg (DE)

Correspondence Address: KENYON & KENYON LLP, ONE BROADWAY, NEW YORK, NY, 10004, US

(21) Appl. No.: 11/497,668

(22) Filed: Aug. 1, 2006

(30) Foreign Application Priority Data
Aug. 3, 2005 (DE) 10 2005 036 438.1

(51) Int. Cl. F01N 3/00; F02D 17/02; F02D 13/06

(52) U.S. Cl. 60/285; 123/198 F

(57) ABSTRACT

A method and a device for operating an internal combustion engine (1) having an exhaust gas treatment system (45), in particular in a non-firing operation of the internal combustion engine (1) are described, which make it possible to implement a different request for change in the temperature gradient of the exhaust gas treatment system (45), in particular via switchover from half-engine operation to full-engine operation. In the event of a request for a change in the temperature gradient of the exhaust gas treatment system (45), a charge cycle state of at least one cylinder (11, 12, . . . 18) of the internal combustion engine (1) is modified.

### FIELD OF THE INVENTION

The invention is directed to a method and a device for operating an internal combustion engine having an exhaust gas treatment system.

### DESCRIPTION OF RELATED ART

Internal combustion engines having exhaust gas treatment systems in the form of catalytic converters are known. Such internal combustion engines are also operated in the non-firing mode, for example, in overrun cut-off (all injectors are closed).

### SUMMARY OF THE INVENTION

In accordance with the invention there is provided a method and device for operating an internal combustion engine (1) having an exhaust gas treatment system (45), in particular in a non-firing operation of the internal combustion engine (1), wherein, in the event of a request for a change in the temperature gradient of the exhaust gas treatment system (45), a charge cycle state of at least one cylinder (11, 12, . . . , 18) of the internal combustion engine (1) is modified. The method according to the invention and the device according to the invention for operating an internal combustion engine having an exhaust gas treatment system have the advantage over the related art that in the event of a request for a change in the temperature gradient of the exhaust gas treatment system a charge cycle state of at least one cylinder of the internal combustion engine is modified. In this way, the modification in the charge cycle state of at least one cylinder of the internal combustion engine is used for implementing or at least for supporting a request for modification of the temperature gradient of the exhaust gas treatment system in such a way that a desired temperature or a desired temperature gradient or a desired change in the temperature gradient of the exhaust gas treatment system can be more rapidly set.

A desired increase in the temperature gradient of the exhaust gas treatment system may be implemented or at least supported in a simple manner in particular by interrupting an activated charge cycle over at least one cylinder of the internal combustion engine. A desired reduction in the temperature gradient of the exhaust gas treatment system may be implemented or at least supported in a simple manner in particular by activating an interrupted charge cycle over at least one cylinder of the internal combustion engine.

It is advantageous in particular if the charge cycle state is modified in one-half of the cylinders, in particular in every other cylinder of the ignition sequence. This makes it possible to implement the modification in the charge cycle state in a particularly simple manner in the case of an internal combustion engine having an even number of cylinder banks by modifying the charge cycle state in all cylinders of one-half of the cylinder banks; the charge cycle state is particularly easily completely interrupted in one-half of the cylinder banks.

If the charge cycle state is modified, in particular interrupted, in every other cylinder of the ignition sequence, a smoother operation of the internal combustion engine is thereby ensured.

The charge cycle state of at least one cylinder is modified in a particularly simple manner by interrupting the charge cycle over the at least one cylinder by deactivating its valve gear on the intake and/or exhaust side, or by activating the charge cycle by activating its valve gear on the intake and/or exhaust side.

If the position of an actuator for affecting the air quantity supplied to the internal combustion engine is modified when the charge cycle state of the at least one cylinder is modified, the charge cycle state of the at least one cylinder may also be advantageously modified, causing less jerk of the internal combustion engine and thus ensuring more comfort, provided the position of the actuator is properly modified.

This is the case, for example, if by interrupting a previously activated charge cycle over at least one cylinder, the position of the actuator in the air supply is modified to reduce the air quantity supplied to the internal combustion engine.

Conversely, this increased comfort when changing the charge cycle state of the at least one cylinder is also provided if by activating a previously interrupted charge cycle over at least one cylinder the position of the actuator in the air supply is modified to increase the air quantity supplied to the internal combustion engine.

The comfort is increased in a simple and defined manner by changing the position of the actuator in the air supply by a predefined value.

It is advantageous in particular if the predefined value is ascertained in such a way that, after the change in the charge cycle state of the at least one cylinder and the simultaneously occurring change in the position of the actuator, the clutch torque also remains constant. In this way, the change in the charge cycle state of the at least one cylinder may be implemented almost jerk-free and thus with maximum comfort. If the internal combustion engine drives a vehicle, the above-described constancy of the clutch torque results, before and after the change in the charge cycle state of the at least one cylinder, in the driver of the vehicle not noticing or almost not noticing this change in the charge cycle state.

### BRIEF DESCRIPTION OF THE DRAWINGS

The invention will be described in greater detail with reference to the following drawings wherein:

FIG. 1 shows a block diagram of an internal combustion engine having two cylinder banks.

FIG. 2 shows a function diagram for modifying the charge cycle state of at least one cylinder of the internal combustion engine as a function of a request.

FIG. 3 shows a function diagram for elucidating the method according to the present invention and the device according to the present invention for modifying the position of an actuator in an air supply of the internal combustion engine as a function of the modification of the charge cycle state of the at least one cylinder.

FIGS. 4a) through 4i) show the variation over time of different performance quantities of the internal combustion engine before and after the modification of the charge cycle state of at least one cylinder of the internal combustion engine.

### DETAILED DESCRIPTION OF THE INVENTION

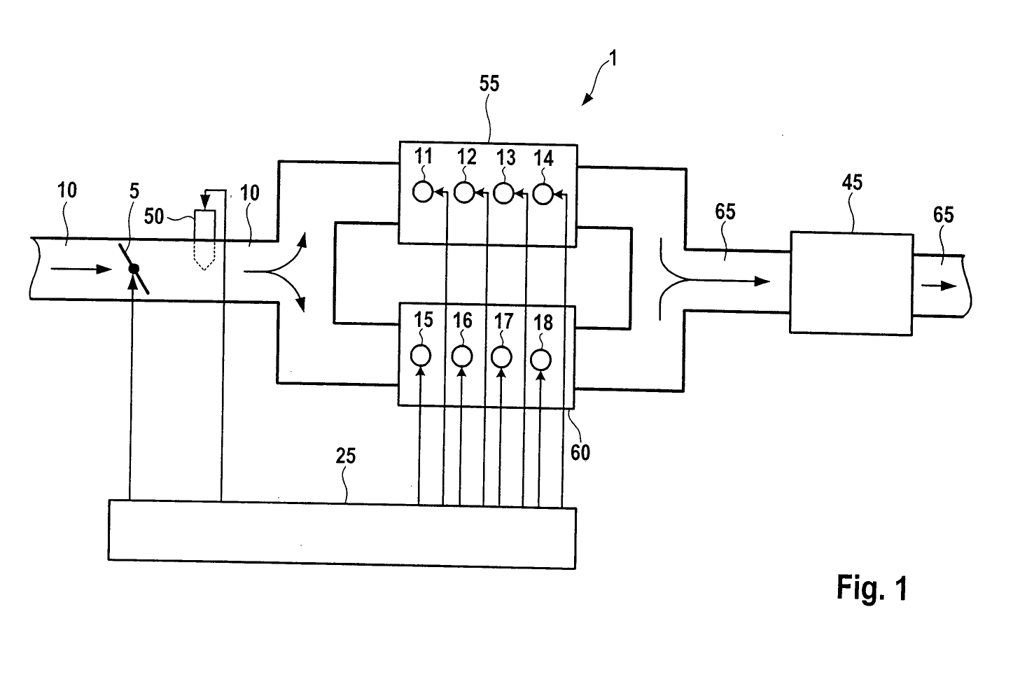

In FIG. 1, reference numeral 1 identifies an internal combustion engine, which drives a vehicle, for example. Internal combustion engine 1 may be designed as a gasoline engine or a diesel engine, for example. In this example, internal combustion engine 1 includes an even number n of cylinder banks; in the example of FIG. 1, n is equal to 2. Alternatively, the present invention may also be implemented using an odd number of cylinder banks, or even a single cylinder bank, for example. Each cylinder bank in the present example includes the same number of cylinders. Internal combustion engine 1 according to FIG. 1 thus includes a cylinder bank 55 having a first cylinder 11, a second cylinder 12, a third cylinder 13, and a fourth cylinder 14. Furthermore, internal combustion engine 1 according to FIG. 1 includes a second cylinder bank 60 having a fifth cylinder 15, a sixth cylinder 16, a seventh cylinder 17, and an eighth cylinder 18. Fresh air is supplied to cylinders 11, . . . , 18 of both cylinder banks 55, 60 via an air supply 10. An actuator 5 is situated in air supply 10 for influencing the air quantity supplied to cylinders 11, . . . , 18. This air quantity varies as a function of the setting or position or opening angle or degree of opening of actuator 5. In the following it will be assumed, for example, that actuator 5 is designed as a throttle valve. The flow direction of the air in air supply 10 is indicated by arrows in FIG. 1. The position of the throttle valve, i.e., the opening angle, is controlled by a controller 25 as known to those skilled in the art, for example, as a function of the operation of an accelerator pedal, not depicted in FIG. 1, or as a function of the request by another vehicle system, not depicted in FIG. 1, such as an antilock system, a traction control system, an electronic stability program, a cruise control system, or the like. Downstream from throttle valve 5, fuel is injected into air supply 10 via an injector 50, injector 50, and thus fuel metering, also being controlled by controller 25 as known to those skilled in the art, for example, for setting a predefined air/fuel mixture ratio. Alternatively, fuel may also be injected into air supply 10 upstream from throttle valve 5 or directly into the combustion chambers of cylinders 11, . . . , 18. Furthermore, according to FIG. 1, the valve gear of cylinders 11, . . . , 18 and thus their intake and exhaust valves are controlled by engine controller 25 as known to those skilled in the art, via a fully variable valve control. Alternatively, this valve gear may also be set using camshafts as known to those skilled in the art. The exhaust gas formed in the combustion chambers of cylinders 11, . . . , 18 by the combustion of the air/fuel mixture is expelled via the exhaust valves of cylinders 11, . . . , 18 into an exhaust gas system 65. The flow direction of the exhaust gas in exhaust system 65 is also indicated in FIG. 1 by arrows. An exhaust gas treatment system 45 in the form of a catalytic converter, for example, is situated in exhaust gas system 65 for preventing, via conversion, the emission of undesirable pollutants as much as possible.

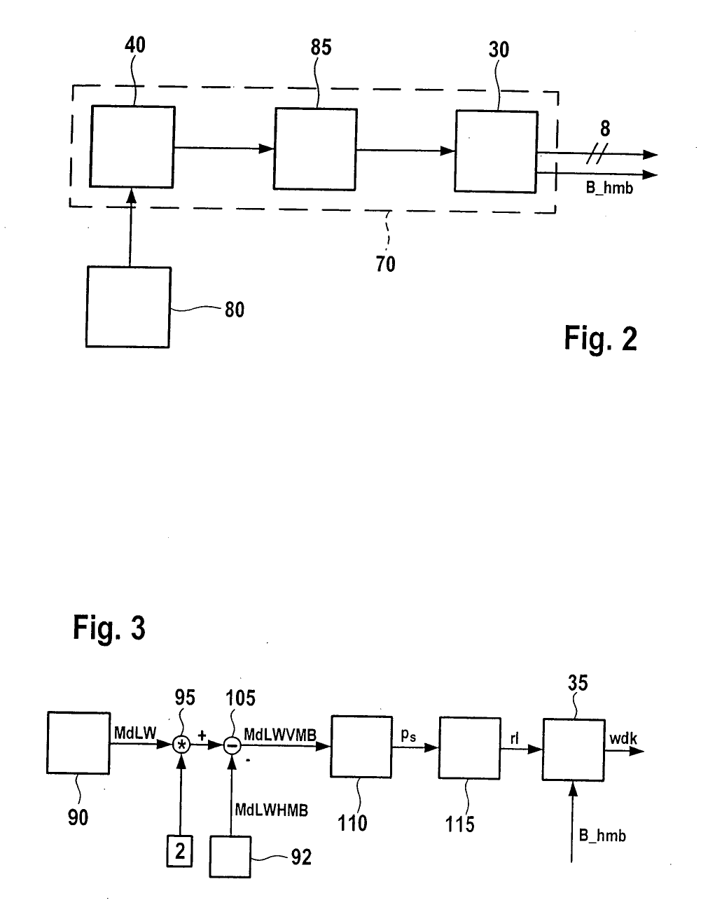

FIG. 2 shows a function diagram labeled with reference numeral 70 with whose help the charge cycle state of at least one of cylinders 11, 12, . . . , 18 of the internal combustion engine is modified as a function of a received request. Function diagram 70 may be implemented as software and/or hardware, for example, in engine controller 25. Function diagram 70 includes a receiver unit 40 for receiving a request from a request generating unit 80 situated outside function diagram 70. Such a request may be a request for modifying the temperature gradient of exhaust gas treatment system 45, for example. Such a request may be generated by engine controller 25, for example. For this purpose, engine controller 25 compares, for example, an actual temperature of catalytic converter 45 with a setpoint temperature of catalytic converter 45, and from this difference deduces a request for modifying the temperature gradient of catalytic converter 45 over time. For example, when the actual temperature of the catalytic converter is less than the setpoint temperature by more than a predefined value, engine controller 25 may request an increase in the temperature gradient. Conversely, when the actual temperature of the catalytic converter exceeds the setpoint temperature of the catalytic converter by more than a predefined value, engine controller 25 may request a decrease in the temperature gradient of catalytic converter 45. The request for modification of the temperature gradient is predefined by request generating unit 80, which may also be implemented in engine controller 25 as software and/or hardware. Another example of a request is a deceleration request for decelerating the vehicle driven by internal combustion engine 1. Such a deceleration request is received by controller 25, for example, due to the operation of a brake pedal by the driver or as a deceleration request of a vehicle system such as, for example, an antilock system, a traction control system, an electronic stability program or the like. In this case, request generating unit 80 represents the corresponding vehicle system or the brake pedal module.

Receiver unit 40 receives the above-described request from request generating unit 80 and relays it to an implementer unit 85 in the function diagram. Implementer unit 85 converts the received request into a request to charge cycle state of cylinders 11, 12, . . . , 18 and relays this request to means 30 for modifying the charge cycle state of cylinders 11, 12, . . . , 18. Means 30 include an actuator system, which sets the valve gear of the intake and/or exhaust valves of each cylinder 11, 12, . . . , 18 according to the request delivered by implementer unit 85. The intake and/or exhaust valves of each cylinder 11, 12, . . . , 18 may be set, i.e., opened or closed, individually by means 30. Each cylinder 11, . . . , 18 includes one or more intake valves and one or more exhaust valves. With the aid of means 30, all intake valves and/or all exhaust valves of each cylinder 11, 12, . . . , 18 may be closed for a longer period, so that the charge cycle over the corresponding cylinder is interrupted, i.e., deactivated for this period. Since each cylinder 11, . . . , 18 may be controlled individually as described above, FIG. 2 shows eight outputs of means 30. A modification of the charge cycle state of at least one of cylinders 11, . . . , 18 thus results from the charge cycle over the at least one cylinder 11, . . . , 18 being interrupted starting from an activated state by closing all of its intake valves and/or all of its exhaust valves for a longer period. Conversely, the charge cycle state of the at least one cylinder 11, . . . , 18 may be modified by reactivating the charge cycle over the at least one cylinder 11, . . . , 18 from a deactivated state by opening and closing the intake valves and/or the exhaust valves of the at least one cylinder 11, . . . , 18 for performing the charge cycle alternatingly in a conventional manner according to the cylinder cycle.

In an advantageous embodiment, a distinction is made between two operating states of internal combustion engine 1 regarding the charge cycle state of cylinders 11, . . . , 18. In a first operating state, the charge cycle is interrupted over one-half of cylinders 11, . . . , 18 by closing their intake and/or exhaust valves for a longer period. The charge cycle over all cylinders of one of the two cylinder banks 55, 60 may be interrupted, while the charge cycle over all cylinders of the other two cylinder banks 55, 60 is activated. Alternatively, also one-half of the cylinders of the first cylinder bank 55 and one-half of the cylinders of the second cylinder bank 60 or in general one-half of the cylinders regardless of which cylinder bank they are located in may be deactivated regarding the charge cycle, while the charging cycle is activated over the other cylinders. In general, and also in the case of an odd number of cylinder banks, only part, for example, one-half, of all cylinders of internal combustion engine 1 is deactivated regarding the charge cycle, and the other part of all cylinders of internal combustion engine 1 is activated regarding the charge cycle. If, for example, the ignition sequence of cylinders 11, . . . , 18 is as follows:

First cylinder 11, fifth cylinder 15, second cylinder 12, sixth cylinder 16, third cylinder 13, seventh cylinder 17, fourth cylinder 14, eighth cylinder 18,

Every other cylinder of the ignition sequence may be excluded from the charge cycle regardless of which cylinder bank it is located in, and the charge cycle may be activated over the other cylinders. In the above-described example, in the case where all cylinders 11, 12, 13, 14 of first cylinder bank 55 are excluded from the charge cycle and the charge cycle over all other cylinders 15, 16, 17, 18 of second cylinder bank 60 is activated, it would result, for example, in every other cylinder in the ignition sequence being excluded from the charge cycle, while the other cylinders in the ignition sequence would have a charge cycle. In this way, the smoothest possible engine operation results despite the charge cycle being interrupted in one-half of the cylinders.

In a second operating state, all cylinders 11, . . . , 18 should be activated regarding the charge cycle.

The charge cycle state of cylinders 11, . . . , 18 is now modified by simply switching between the first operating state and the second operating state. The first operating state is referred to as half-engine operation and the second operating state as full-engine operation. This switch between the two operating states may occur in both firing and non-firing operation of internal combustion engine 1. In non-firing operation, fuel injection via injector 50 is interrupted for a longer period, in contrast to firing operation, during which fuel is regularly injected. Firing operation of internal combustion engine 1 means, for example, “pull” operation, and non-firing operation exists, for example, in an overrun operation of internal combustion engine 1. Non-firing overrun operation of internal combustion engine 1 is also known as overrun cut-off, i.e., the corresponding injectors of all cylinders are closed.

In the following, it is assumed as an example that switching between the first operating state and the second operating state occurs in non-firing operation of internal combustion engine 1, for example, during overrun cut-off.

Optionally, when the charge cycle state of the at least one cylinder 11, . . . , 18 is modified, the position of throttle valve 5 is modified; as described above, in this exemplary embodiment the modification of the charge cycle state of the at least one cylinder 11, . . . , 18 is represented by switching between the first operating state and the second operating state. The objective of this measure is to avoid, as much as possible, a jerk of internal combustion engine 1, i.e., of the vehicle driven by it, when switching between the first operating state and the second operating state, thus making the operation of the engine more comfortable. For this purpose, when a previously activated charge cycle is interrupted over at least one cylinder 11, . . . , 18, the position of throttle valve 5 is changed to reduce the air quantity supplied to internal combustion engine 1. This means that, when switching from the second operating state to the first operating state, the throttle valve is operated in the direction of closing.

Similarly, when a previously interrupted charge cycle over at least one cylinder 11, . . . , 18 is activated, the position of throttle valve 5 is changed to increase the air quantity supplied to internal combustion engine 1. This means that, when switching from the first operating state to the second operating state, throttle valve 5 is operated in the direction of opening.

It has been found to be advantageous to change the position of throttle valve 5 by a predefined value. The predefined value is ascertained in such a way that, after the modification of the charge cycle state of the at least one cylinder 11, 12, . . . , 18, and the change in the position of throttle valve 5 occurring simultaneously with the modification of the charge cycle state, the clutch torque of internal combustion engine 1 remains constant compared to the state prior to the modification of the charge cycle state of the at least one cylinder 11, . . . , 18. In this way, in the ideal case, the jerk of internal combustion engine 1, i.e., of the vehicle, is fully avoided, with the modification of the charge cycle state of the at least one cylinder 11, . . . , 18. The predefined value for the change in the position of throttle valve 5 may be ascertained via calibration, for example, on a test bench, as a function of the instantaneous operating state of internal combustion engine 1, in particular as a function of the speed and the load of internal combustion engine 1. As an alternative, the predefined value may be ascertained via modeling. An example of such a modeling of the predefined value for changing the position of throttle valve 5 is elucidated with reference to function diagram 75 in FIG. 3.

A torque loss appears at the output of internal combustion engine 1 due to the engine friction and the charge cycle losses. The torque loss is equal to the sum of the friction torque and the charge cycle torque loss. The instantaneous charge cycle torque loss value is ascertained in a first torque ascertaining unit 90 of second function diagram 75 as known to those skilled in the art. Ideally, the instantaneous charge cycle torque loss value in the first operating state must be equal to that in the second operating state. Since the charge cycle torque loss value in the first operating state is only one-half of that in the second operating state, the instantaneous charge cycle torque loss value must be multiplied by the factor two in a multiplication element 95. The charge cycle torque loss value obtained for the cylinder in which the charge cycle is interrupted is subtracted from the product formed in this way in a subtraction element 105 of function diagram 75. This value is ascertained in a second torque ascertaining unit 92 and is equal to zero in the first operating state of internal combustion engine 1, because in the cylinders in which the charge cycle is interrupted no charge cycle losses or charge cycle torque losses may occur. The difference at the output of subtraction element 105 is therefore equal to the charge cycle torque loss value of those cylinders whose charge cycle is activated. This charge cycle torque loss value of the cylinders having activated charge cycles is supplied, for example, to an inverse integral function

$${( {\int }_{pV}^{ps} p * ⅆ V )}^{- 1}$$

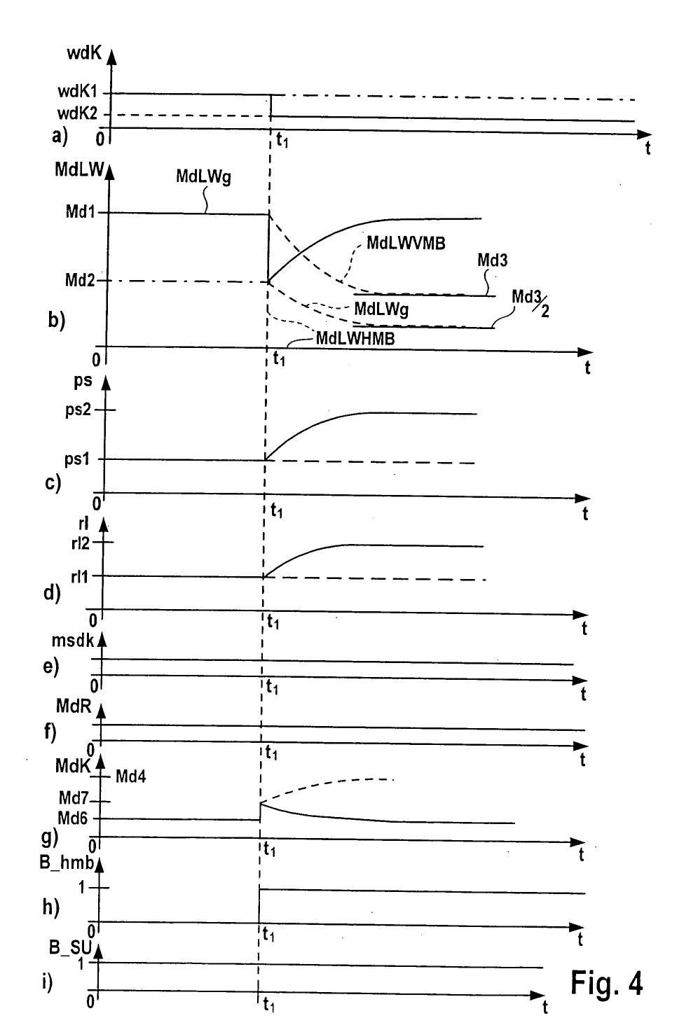

of the pV diagram of internal combustion engine 1 as an input value, pₛ being the intake manifold pressure downstream from throttle valve 5 and pᵤ being the ambient pressure. Intake manifold pressure pₛ associated with the charge cycle torque loss value of the cylinders having activated charge cycles is then obtained at the output of the inverse integral function. Ambient pressure pᵤ may be ascertained as known to those skilled in the art, for example, with the help of a pressure sensor not depicted in FIG. 1. Instead of the inverse integral function, a characteristic map or a characteristic curve, calibrated on a test bench for example, may also be used. The inverse integral function is labeled in FIG. 3 with the reference numeral 110. Intake manifold pressure pₛ at the output of inverse integral function 110 is supplied to a characteristic curve 115, which converts intake manifold pressure pₛ into the associated value for cylinder charge rl. In the simplest case, instead of characteristic curve 115, a multiplication element may be used, which multiplies intake manifold pressure pₛ by a conversion factor fupsrl to obtain the value for charge rl. The conversion factor or characteristic curve 115 may also be calibrated on a test bench, for example, as a function of the operating state of internal combustion engine 1, i.e., in particular of the engine speed and engine load. Charge rl ascertained from characteristic curve 115 or via conversion is supplied to an actuator unit 35 of function diagram 75, which ascertains the opening angle of throttle valve 5, associated with charge rl. Actuator unit 35 causes the opening angle of throttle valve 5 to be set at the ascertained opening angle, thus causing a change in the opening angle of throttle valve 5 by a value defined by the opening angle ascertained by actuator unit 35 and an opening angle existing prior to switching between the first and second operating states. Actuator unit 35 causes throttle valve 5 to operate in the closing direction toward the ascertained opening angle when a switchover from the second operating state to the first operating state has been detected. However, if a switchover from the first operating state to the second operating state has occurred, actuator 35 causes throttle valve 5 to operate in the opening direction toward the ascertained opening angle. Whether a switchover from the first operating state to the second operating state or from the second operating state to the first operating state has occurred is detected by actuator unit 35 via the supply of a B_hmb signal which is shown in FIG. 4h). This signal is set in the first operating state and reset in the second operating state and is generated and output by means 30 as a function of the charge cycle state request of the cylinders. This signal is then supplied to actuator 35.

In the ideal case, a change in the clutch torque of internal combustion engine 1 due to switching between the first operating state and the second operating state is fully compensated by the change in the position of throttle valve 5 by actuator 35. The charge cycle torque loss value at the output of first torque ascertaining unit 90 is labeled MdLW. The output of second torque ascertaining unit 92 as charge torque loss value of the cylinders not activated regarding the charge cycle is labeled MdLWHMB; the output of subtraction element 105 as charge cycle torque loss value of the cylinders activated regarding the charge cycle is labeled MdLWVMB; the output of inverse integral function 110 is labeled intake manifold pressure pₛ; the output of characteristic curve 115 is labeled charge rl, and the value at the output of actuator 35 is labeled wdk. When a switchover occurs from the second operating state to the first operating state, charge cycle torque loss value MdLWHMB ascertained by second torque ascertaining unit 92 is zero as described above, and thus MdLWVMB is equal to 2*MdLW. When a switchover occurs from the first operating state to the second operating state, charge cycle torque loss value MdLWHMB ascertained by second torque ascertaining unit 92 is the charge cycle torque loss value of those cylinders which were shut off regarding the charge cycle and are now activated. Thus, MdLWHMB=0.5*MdLW=MdLWVMB.

The functioning of function diagram 75 of FIG. 3 is now elucidated with reference to the time diagrams of different performance quantities of internal combustion engine 1 according to FIGS. 4a) through 4i) using the example of the switchover from the second operating state to the first operating state.

According to FIG. 4i), a B_SU signal is continuously set over the considered period of time and thus indicates that an overrun cut-off exists. If the B_SU signal is reset, there is no overrun cut-off. The B_SU signal is generated by engine controller 25. Furthermore, FIG. 4h) shows the curve of the B_hmb signal which is generated, as described above, by means 30. This B_hmb signal is reset up to a first point in time t₁ and is set at point in time t₁ to remain set thereafter. This means that internal combustion engine 1 is in the second operating state up to first point in time t₁, after which it is in the first operating state. At first point in time t₁ a switchover thus occurs from full-engine operation to half-engine operation. According to FIG. 4a), up to first point in time t₁, the degree of opening of throttle valve 5 is equal to wdk1. Without the above-described function of second function diagram 75, the degree of opening of throttle valve 5 would assume the value wdk1 even after first point in time t₁, i.e., it would remain unchanged, provided constant boundary conditions existed, in particular in the form of a constant driver's intent or constant requests from other vehicle systems such as, for example, antilock system, traction control system, electronic stability program, cruise control, or the like. Due to the cylinders that were shut down at first point in time t₁ [and are in] half-engine operation and the absence of charge cycling in that state, the flow rate in the intake manifold, which characterizes the part of air supply downstream from throttle valve 5, is reduced. Intake manifold pressure pₛ thus rises, starting at first point in time t₁, from a first value pₛ₁ asymptotically to a second value pₛ₂ according to FIG. 4c), because the degree of opening of throttle valve 5 remains constant. The curve of intake manifold pressure pₛ is therefore not discontinuous, but continuous, because intake manifold pressure pₛ must build up downstream from throttle valve 5 over time. The charge cycle losses are caused by the pressure ratio of intake manifold pressure pₛ to ambient pressure pᵤ according to the p-V diagram of internal combustion engine 1. The charge cycle torque loss drops with increasing intake manifold pressure pₛ. In addition, the charge cycle losses across the intake and exhaust valves of cylinders 11, . . . , 18 are reduced, because only one-half of cylinders 11, . . . , 18 are active regarding the charge cycle. The total charge cycle torque loss MdLWg up to first point in time t₁ is equal to Md1 according to FIG. 4b). The total charge cycle torque loss MdLWg up to first point in time t₁ is equal to the charge cycle torque loss of both first cylinder bank 55 and second cylinder bank 60. The total charge cycle torque loss MdLWg is always the mean value of the charge cycle torque losses of the two cylinder banks 55, 60. At first point in time t₁ charge cycle torque loss MdLWHMB of the cylinder bank deactivated at first point in time t₁ regarding the charge cycle jumps to the value zero. Due to the increasing intake manifold pressure pₛ, starting at first point in time t₁, charge cycle torque loss MdLWVMB of the cylinder bank whose cylinders are still activated after first point in time t₁ regarding the charge cycle also drops asymptotically to a value Md3. The curve of the total charge cycle torque loss MdLWg is thus obtained as the mean value of charge cycle torque losses MdLWHMB, MdLWVMB of the two cylinder banks as depicted in FIG. 4b). The total charge cycle torque loss MdLWg therefore jumps at first point in time t₁ to a value Md2=½ Md1 and from there it drops asymptotically toward a value Md3/2, Md3 being less than Md2 in the example of FIG. 4b). As FIG. 4d) shows, starting at a first value rl1, charge rl also increases asymptotically toward a second value rl2 with charge pressure pₛ from first point in time t₁. According to FIG. 4e), air mass flow msdk through throttle valve 5 remains constant. over the entire time period under consideration, provided internal combustion engine 1 is being operated above the critical operating range in which air moves in air supply 10 at the speed of sound.

According to FIG. 4f), friction torque Mdr is also assumed to be constant over the entire time period. Clutch torque MdK, the difference between internal torque Mi and the total torque loss Mv of internal combustion engine 1, jumps at first point in time t₁ from a value Md6 to a value Md7>Md6 and increases from value Md7 for times t>t₁ to a value Md4 according to the dashed line in FIG. 4g). Torque loss Mv of internal combustion engine 1 is equal to the sum of friction torque MdR and the total charge cycle torque loss MdLWg. Thus, assuming a constant internal torque Mi=0 of internal combustion engine 1, clutch torque MdK varies inversely to the total charge cycle torque loss MdLWg.

According to FIG. 3, using function diagram 75 according to the present invention, charge cycle torque loss MdLWVMB is detected, in particular starting at first point in time t₁ as described above, and the associated intake manifold pressure pₛ is ascertained with the aid of the pV diagram, and therefrom charge rl and therefrom the required position of throttle valve 5, for compensating the above-mentioned changes in charge rl, intake manifold pressure pₛ, and charge cycle torque loss MdLWVMB. This position of the throttle valve is set at first point in time t₁ via actuator 35, which is manifested in a change from degree of opening wdk1 to degree of opening wdk2<wdk1 at first point in time t₁ according to the solid curve of degree of opening wdk in FIG. 4a). Ultimately this results in both charge rl, according to the dashed curve in FIG. 4d), and intake manifold pressure pₛ remaining constant after point in time t₁ compared to the time before point in time t₁. For the curve of total charge cycle torque loss MdLWg according to the solid line in FIG. 4b), this means that the total charge cycle torque loss MdLWg rises again asymptotically toward value Md1 after jumping to value Md2=0.5*Md1 at first point in time t₁. Similarly, clutch torque MdK jumps from value Md6 to value Md7>Md6 at first point in time t₁, and subsequently goes back asymptotically toward value Md6. In the method according to the present invention, clutch torque MdK may thus be held constant at value Md6 in comparison with the dashed curve, except for the above-mentioned jump. This results in the driver of the vehicle driven by internal combustion engine 1 perceiving the switch from the second operating state to the first operating state at first point in time t₁ minimally (due to the above-mentioned jump) or not at all.

Due to the above-described measure according to the present invention, the intake manifold pressure increase starting at first point in time t₁ is thus almost fully compensated. Consequently, intake manifold pressure pₛ remains approximately constant as described above. If intake manifold pressure pₛ remains approximately constant, the intake manifold pressure pₛ to ambient pressure pᵤ ratio will also remain constant. As described previously, this results in the total charge cycle torque loss MdLWg returning asymptotically to the original value Md1 after the jump at point in time t₁, as clutch torque MdK consequently returns asymptotically to the original value Md6 after the jump at first point in time t₁.

If a switch occurs from half-engine operation to full-engine operation, a jerk of internal combustion engine 1 due to this switchover may be largely avoided by appropriately increasing the degree of opening of throttle valve 5 similarly to FIG. 4, for example, with the switchover to full-engine operation to asymptotically bring back total charge cycle torque loss MdLWg and thus clutch torque MdK, after the jump caused by the switchover, to the value that existed immediately prior to the jump and thus prior to the switchover to full-engine operation. In a similar manner, intake manifold pressure pₛ and charge rl remain approximately constant when a switchover from half-engine operation to full-engine operation occurs.

Fresh air is passed through cylinders 11, . . . , 18, and catalytic converter 45 is purged with fresh air, mainly in the non-firing state of internal combustion engine 1 with the charge cycle of all of these cylinders 11, . . . , 18 activated. The temperature of catalytic converter 45 changes at this time. The mass flow of the air passed through the cylinders, and thus the temperature of catalytic converter 45, is affected by the interruption of the charge cycle in at least one of cylinders 11, . . . , 18. If the charge cycle of all cylinders of a cylinder bank is interrupted at this time, the associated exhaust gas system of this cylinder bank is operated without mass flow. Catalytic converter 45 is not purged with fresh air by this cylinder bank due to the cylinder bank being fully deactivated regarding the charge cycle. If all cylinder banks are fully deactivated regarding the charge cycle, air will reach catalytic converter 45 only through the end pipe of exhaust gas system 65 downstream from catalytic converter 45, reducing the temperature of catalytic converter 45. If only one-half of the cylinders of the two cylinder banks are deactivated regarding the charge cycle, or only one of the two cylinder banks is fully deactivated and the other cylinder bank is not deactivated at all, the mass flow through catalytic converter 45 is cut in half or at least reduced. The catalytic converter is thus purged with less fresh air than in full-engine operation and its temperature also changes. Whenever a catalytic converter is associated with a plurality of cylinder banks, the mass flow through the associated catalytic converter may be reduced to zero if a full cylinder bank is shut off.

The main object of the present invention is to implement a request for change in the temperature gradient of catalytic converter 45 or in general of the exhaust gas treatment system by changing the charge cycle state of at least one of cylinders 11, 12, . . . , 18 of internal combustion engine 1. For this purpose, receiver unit 40 of function diagram 70 receives a request, from request generating-unit 80, as described previously, to increase the temperature gradient of catalytic converter 45 or to reduce the temperature gradient of catalytic converter 45. Depending on the received request, implementing unit 85 generates a request for setting the first operating state or the second operating state of internal combustion engine 1. In the event of a request for an increase of the temperature gradient of catalytic converter 45, implementing unit 85 generates a request for the first operating state, i.e., the half-engine operation. In the event of a request for a reduction of the temperature gradient of catalytic converter 45, implementing unit 85 generates a request for the second operating state, i.e., the full-engine operation. In general, in the event of a request for an increase in the temperature gradient of catalytic converter 45, implementing unit 85 generates a request for interrupting an activated charge cycle over at least one of cylinders 11, 12, . . . , 18 of internal combustion engine 1. In the event of a request for a reduction in the temperature gradient of catalytic converter 45, implementing unit 85 typically generates a request for activating an interrupted charge cycle over at least one of cylinders 11, 12, . . . , 18 of internal combustion engine 1. The request to change the charge cycle state of the at least one cylinder 11, 12, . . . , 18 of the internal combustion engine, in particular the request for setting the half-engine operation or the full-engine operation, is then implemented by means 30 as described above by appropriately controlling the intake/exhaust valves of the cylinder(s) whose charge cycle state is to be modified. If means 30 switch from full-engine operation to half-engine operation, catalytic converter 45 is purged using less fresh air than previously, so that the temperature gradient of catalytic converter 45 is increased. If means 30 switch from half-engine operation to full-engine operation, catalytic converter 45 is purged using more-fresh air than previously, so that the temperature gradient of catalytic converter 45 is reduced as a result.

In order to exert the least possible influence of the above-described purging of the catalytic converter on the drivability of the vehicle, the above-described method of switching between half-engine operation and full-engine operation is used for purging catalytic converter 45, preferably during the overrun cut-off, i.e., in the non-firing operation of the internal combustion engine; the above-described method of purging the catalytic converter described by function diagram 75 and elucidated with reference to FIGS. 4a) through 4i) may be performed in such a way that it takes place as smoothly as possible with the driver noticing as little as possible or nothing. The method described by function diagram 75 and elucidated with reference to FIGS. 4a) through 4i is not absolutely necessary for purging the catalytic converter according to the present invention.

The charge cycle over the at least one cylinder 11, 12, . . . , 18 is interrupted by closing its intake and/or exhaust valves for a longer period or, in other words, by deactivating its valve gear on the intake and/or exhaust side. The charge cycle over the at least one cylinder 11, 12, . . . , 18 is activated by operating the intake and/or exhaust valves of this at least one cylinder 11, 12, . . . , 18 in a conventional manner as described above or, in other words, by activating the valve gear of this at least one cylinder on the intake and/or exhaust side.

What is claimed is:

1. A method for operating an internal combustion engine (1) having an exhaust gas treatment system (45), in a non-firing operation of the internal combustion engine (1), comprising: modifying a charge cycle state of at least one cylinder (11, 12, . . . , 18) of the internal combustion engine (1) in the event of a request for a change in the temperature gradient of the exhaust gas treatment system (45).

2. The method according to claim 1, wherein an activated charge cycle over at least one cylinder (11, 12, . . . , 18) of the internal combustion engine (1) is interrupted for increasing the temperature gradient or an interrupted charge cycle over at least one cylinder (11, 12, . . . , 18) of the internal combustion engine (1) is activated for reducing the temperature gradient.

3. The method according to claim 1, wherein the charge cycle state in one-half of the cylinders (11, 12, . . . , 18), and in every other cylinder (11, 12, . . . , 18) of the ignition sequence, is modified.

4. The method according to claim 2, wherein the charge cycle state in one-half of the cylinders (11, 12, . . . , 18), and in every other cylinder (11, 12, . . . , 18) of the ignition sequence, is modified.

5. The method according to claim 1, wherein the charge cycle over the at least one cylinder (11, 12, . . . , 18) is interrupted by deactivating its valve gear on at least one of the intake and exhaust side, or is activated by activating its valve gear on at least one of the intake and exhaust side.

6. The method according to claim 2, wherein the charge cycle over the at least one cylinder (11, 12, . . . , 18) is interrupted by deactivating its valve gear on at least one of the intake and exhaust side, or is activated by activating its valve gear on at least-one of the intake and exhaust side.

7. The method according to claim 3, wherein the charge cycle over the at least one cylinder (11, 12, . . . , 18) is interrupted by deactivating its valve gear on at least one of the intake and exhaust side, or is activated by activating its valve gear on at least one of the intake and exhaust side.

8. The method according to claim 1, wherein, with the modification of the charge cycle state of the at least one cylinder (11, 12, . . . , 18), the position of an actuator (5) for influencing the air quantity supplied to the internal combustion engine (1) is modified.

9. The method according to claim 2, wherein, with the modification of the charge cycle state of the at least one cylinder (11, 12, . . . , 18), the position of an actuator (5) for influencing the air quantity supplied to the internal combustion engine (1) is modified.

10. The method according to claim 3, wherein, with the modification of the charge cycle state of the at least one cylinder (11, 12, . . . , 18), the position of an actuator (5) for influencing the air quantity supplied to the internal combustion engine (1) is modified.

11. The method according to claim 5, wherein, with the modification of the charge cycle state of the at least one cylinder (11, 12, . . . , 18), the position of an actuator (5) for influencing the air quantity supplied to the internal combustion engine (1) is modified.

12. The method according to claim 8, wherein, with the interruption of a previously activated charge cycle over at least one cylinder (11, 12, . . . , 18), the position of the actuator (5) in the air supply (10) is modified for reducing the air quantity supplied to the internal combustion engine (1).

13. The method according to claim 9, wherein, with the interruption of a previously activated charge cycle over at least one cylinder (11, 12, . . . , 18), the position of the actuator (5) in the air supply (10) is modified for reducing the air quantity supplied to the internal combustion engine (1).

14. The method according to claim 8, wherein, with the activation of a previously interrupted charge cycle over at least one cylinder (11, 12, . . . , 18), the position of the actuator (5) in the air supply (10) is modified for increasing the air quantity supplied to the internal combustion engine (1).

15. The method according to claim 12, wherein, with the activation of a previously interrupted charge cycle over at least one cylinder (11, 12, . . . , 18), the position of the actuator (5) in the air supply (10) is modified for increasing the air quantity supplied to the internal combustion engine (1).

16. The method according to claim 8, wherein the position of the actuator (5) in the air supply (10) is modified by a predefined value.

17. The method according to claim 12, wherein the position of the actuator (5) in the air supply (10) is modified by a predefined value.

18. The method according to claim 14, wherein the position of the actuator (5) in the air supply (10) is modified by a predefined value.

19. The method according to claim 16, wherein the predefined value is ascertained in such a way that, after the modification of the charge cycle state of the at least one cylinder (11, 12, . . . , 18) and the simultaneously occurring modification of the position of the actuator (5), the clutch torque remains constant.

20. A device (25) for operating an internal combustion engine (1) having an exhaust gas treatment system (45), in a non-firing operation of the internal combustion engine (1), comprising means (30) for modifying a charge cycle state of at least one cylinder (11, 12, . . . , 18) of the internal combustion engine (1) in the event of a request for a change in the temperature gradient of the exhaust gas treatment system (45).
